(19) United States
(12) Patent Application Publication
(10) Pub. No.: US 2015/0019221 A1
(43) Pub. Date: Jan. 15, 2015

(54) SPEECH RECOGNITION SYSTEM AND METHOD

(71) Applicant: CHUNGHWA PICTURE TUBES, LTD., Taoyuan (TW)

(72) Inventors: Guan-Liang LEE, Taipei City (TW); Chih-Yin CHIANG, Nantou County (TW); Che-Wei CHANG, Taoyuan County (TW)

(73) Assignee: CHUNGHWA PICTURE TUBES, LTD., Taoyuan (TW)

(21) Appl. No.: 14/070,594

(22) Filed: Nov. 4, 2013

(30) Foreign Application Priority Data
Jul. 15, 2013 (TW) 102125241

(51) Int. Cl. G10L 15/08

(52) U.S. Cl. CPC G10L 15/08
USPC 704/246

(57) ABSTRACT

A speech recognition system includes a server, a data transmission interface and a speech recognition device. The speech recognition device builds a connection with the server through the data transmission interface. The speech recognition device includes a microphone, an output unit and a processing unit. The processing unit transmits received user information to the server through the data transmission interface to obtain a corresponding personal dictionary file. The personal dictionary file is generated according to history of speech recognition result and related data, which is used by others recently. The processing unit receives a voice signal to be recognized through the microphone and converts it into a digital characteristic file according to a voiceprint file of the user. The processing unit searches the personal dictionary file according to the digital characteristic file to obtain a speech recognition result for outputting through the output unit.

This application claims priority to Taiwanese Application Serial Number 102125241, filed Jul. 15, 2013, which is herein incorporated by reference.

### BACKGROUND

1. Technical Field

The present invention relates to a speech recognition system and a speech recognition method.

2. Description of Related Art

A speech recognition technology is used to covert voice vocabulary into an input accessible by computers, such as a series of push button signals, binary codes or words. Currently, a rule-based model or a statistical model is often used for performing searches or comparisons for speech recognition. The rule-based model is used to perform speech recognition by analyzing grammar or sentence structures in speech. The statistical model is used to perform speech recognition by searching data in speech unit with probability and statistics methods. No matter which model is used, both models are complicated to perform speech recognition.

In a conventional speech recognition system, its entire system is often implemented on a single-user device. Such implementation consumes more computation resources of the user device to achieve real-time speech recognition and high recognition correctness rate. In addition, such user device often adopts a close system structure, thus not convenient for users to update dictionary files.

Therefore, there is a need to reduce the computation resources consumed by the user device for speech recognition.

### SUMMARY

According to one embodiment of this invention, a speech recognition system is provided to perform speech recognition according to a personal dictionary file corresponding to a user. The speech recognition system includes a server, a data transmission interface and a speech recognition device. The speech recognition device builds a connection with the server through the data transmission interface. The speech recognition device includes a microphone, an output unit and a processing unit. The processing unit is electrically connected to the microphone and the output unit. The processing unit includes a user-information receiving module, a personal-dictionary obtaining module, a speech-signal receiving module, an audio converting module and a searching module. The user-information receiving module receives user information of a user. The personal-dictionary obtaining module transmits the user information to the server through the data transmission interface to obtain a personal dictionary file corresponding to the user information. The speech-signal receiving module receives a speech signal of the user to be recognized through the microphone. The audio converting module converts the speech signal to be recognized into a digital characteristic file according to a voiceprint file corresponding to the user. The searching module searches the personal dictionary file according to the digital characteristic file to obtain a speech recognition result, and outputs the speech recognition result through the output unit.

According to another embodiment of this invention, a speech recognition method is provided. The speech recognition method includes the following steps:

(a) User information of a user is received through a speech recognition device,

(b) The user information is transmitted to a server through the speech recognition device to obtain a personal dictionary file corresponding to the user information.

(c) A speech signal of the user to be recognized is received through a microphone of the speech recognition device.

(d) The speech signal to be recognized is converted into a digital characteristic file according to a voiceprint file corresponding to the user through the speech recognition device.

(e) The personal dictionary file is searched according to the digital characteristic file to obtain a speech recognition result through the speech recognition device, and the speech recognition result is output.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 illustrates a block diagram of a speech recognition system according to one embodiment of this invention; and

FIG. 2 illustrates a flow chart showing a speech recognition method according to one embodiment of this invention

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

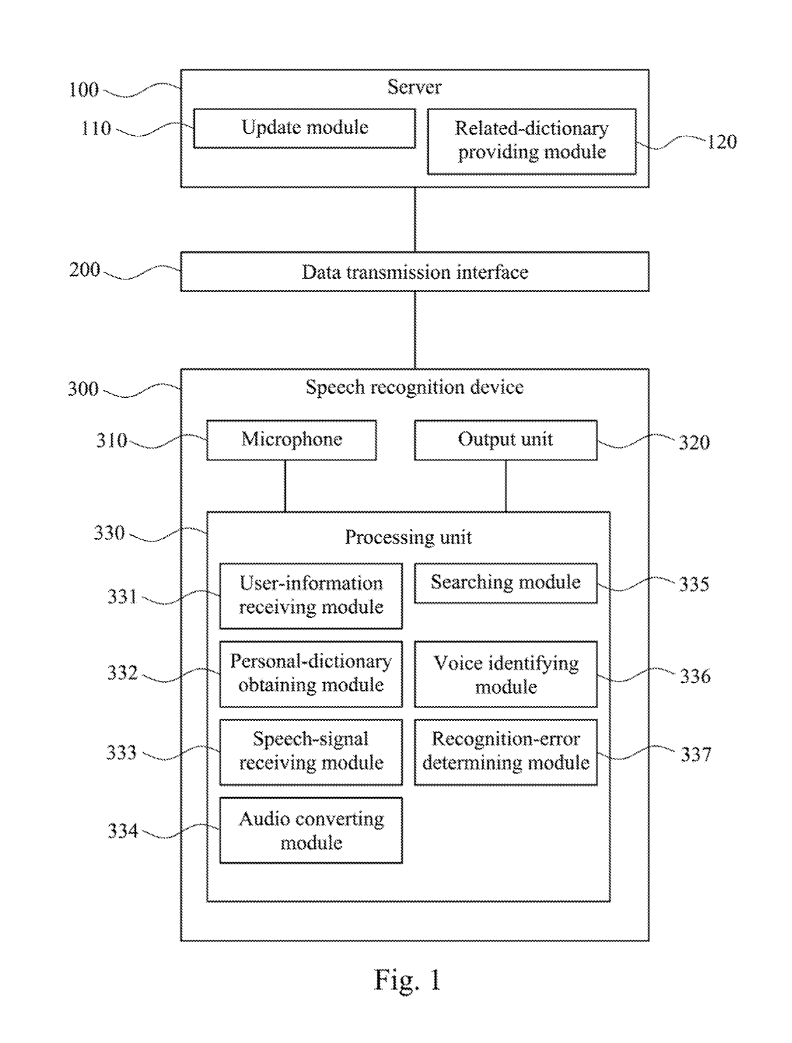

Referring to FIG. 1, a block diagram is described to illustrate a speech recognition system according to one embodiment of this invention. The speech recognition system performs speech recognition according to a personal dictionary file corresponding to a user.

The speech recognition system includes a server 100, a data transmission interface 200 and a speech recognition device 300. In some embodiments, the server 100 is provided by at least one server. When the server 100 is provided by utilizing several servers, these servers may include at least one local server, at least one cloud server or a combination thereof. The local server may store a local dictionary for providing services to local users, and the cloud server may store several professional dictionary files corresponding to several professional domains.

The data transmission interface 200 may be based on a wired or wireless network communication protocol. In some embodiments, the data transmission interface 200 may be any type of wired or wireless data transmission interface, and is not limited to this disclosure.

The speech recognition device 300 builds a connection with the server 100 through the data transmission interface 200 The speech recognition device 300 includes a microphone 310, an output unit 320 and a processing unit 330. The processing unit 330 is electrically connected to the microphone 310 and the output unit 320.

The processing unit 330 may be a central processing unit (CPU), a control unit or any other type of processing unit, which can perform speech-recognition related functions. The processing unit 330 includes a user-information receiving module 331, a personal-dictionary obtaining module 332, a speech-signal receiving module 333, an audio converting module 334 and a searching module 335. The user-information receiving module 331 receives user information of a user. In some embodiments, the user can input his or her information (such as identification information) through a keyboard, a mouse, a Graphical User Interface (GUI) or any other type of input interface to provide his/her information to the user-information receiving module 331. In some embodiments, a voice identifying module 336 of the processing unit 330 can receive the voice signal of the user through the microphone 310. The voice identifying module 336 can identify who the user is according to the voice signal of the user to generate an identification result. Hence, the voice identifying module 336 can correspondingly generate the user information of the user according to the identification result to provide to the user-information receiving module 331. In some embodiments, the voice identifying module 336 can identify user identification information corresponding to the voice signal of the user as his or her user information. In some other embodiments, the voice identifying module 336 can identify a voice category corresponding to the user voice signal of the user, such as a language category, a accent category, or any other voice category, as his or her user information.

The personal-dictionary obtaining module 332 transmits the user information of the user to the server 100 through the data transmission interface 200 to obtain a personal dictionary file corresponding to the user information. In some embodiments, the personal dictionary file is generated according to speech recognition history of the user and related information used by others recently. For example, the personal-dictionary obtaining module 332 may obtain the personal dictionary file formed by at least one common word commonly used by the user. In another example, the personal-dictionary obtaining module 332 may obtain the personal dictionary file according to the language of the user, the accent of the user or other voice parameter of the user embedded in the user information.

The speech-signal receiving module 333 receives the speech signal of the user to be recognized through the microphone 310. The audio converting module 334 converts the speech signal of the user to be recognized into a digital characteristic file according to a voiceprint file corresponding to the user. Therefore, by considering to each voice characteristic and personal dictionary file of the user, the speech-recognition correct ratio can be enhanced. In addition, since the size of the digital characteristic file is smaller than that of the speech signal of the user to be recognized, the time for the speech recognition can be shortened

The searching module 335 searches the personal dictionary file according to the digital characteristic file to obtain a speech recognition result, and outputs the speech recognition result through the output unit 320. In one embodiment, the output unit 320 can be a display unit for displaying the speech recognition result. In another embodiment, the output unit 320 can be a loudspeaker for generating sound representing the speech recognition result. In other embodiments, the output unit 320 may output the speech recognition result in other output forms, which are not limited in this disclosure. Therefore, the speech recognition device 300 can recognize speech precisely without needing to store a large number of dictionary files. Accordingly, a processing unit with poor processing efficiency or a storage unit with a small storage space can be utilized for the speech recognition device 300.

Moreover, in some embodiments, the user may give feedback about whether the speech recognition result is correct or not through a keyboard, a mouse, a GUI or any other type of output interface of the speech recognition device 300. In some other embodiments, the processing unit 330 may further include a recognition-error determining module 337. When the speech recognition result is wrong, most users may repeat his/her word or sentence for performing speech recognition again. Hence, the recognition-error determining module 337 may determine another speech signal of the user received through the microphone 310 is the same as the previous speech signal of the user to be recognized. When another speech signal received through the microphone 310 is the same as the previous speech signal of the user to be recognized, the recognition-error determining module 337 may determine that the speech recognition result is erroneous. Therefore, when the user notices that the speech recognition result is erroneous, the user may simply repeat the same word or sentence to drive the speech recognition device 300 to determine that the speech recognition result is erroneous and to modify the speech recognition result, which is easy for the user to operate.

An update module 110 of the server 100 may receive information regarding whether the speech recognition result is correct or not from the speech recognition device 300 through the data transmission interface 200. Accordingly, the update module 110 may update the personal dictionary file according to the received information regarding whether the speech recognition result is correct or not. For example, the update module 110 may adjust (increase or decrease) the weight of the corresponding words in the personal dictionary file according to the information about whether the speech recognition result is correct or not, which can enhance the recognition correctness ratio.

In some embodiments, the server 100 may further include a related-dictionary providing module 120. The related-dictionary providing module 120 receives the speech recognition result through the data transmission interface 200, and transmits a related dictionary file to the speech recognition device 300 according to the speech recognition result for the searching module 335 to perform searching. For example, when the related-dictionary providing module 120 determines that the speech recognition result is related to weather, the related-dictionary providing module 120 may deliver a dictionary related to weather to the speech recognition device 300. The dictionary related to weather may store words or sentences about weather. Therefore, the recognition correctness ratio of the speech recognition device 300 can be raised. In addition, additional time for modifying the speech recognition result or for re-transmitting another dictionary due to incorrect speech recognition results can be saved.

In other embodiments, if the server 100 includes a local server, the local server may store a recently used dictionary file. Since users served by the same local server may have similar speech contents or words, the file size of the recently used dictionary file stored in the local server can be reduced.

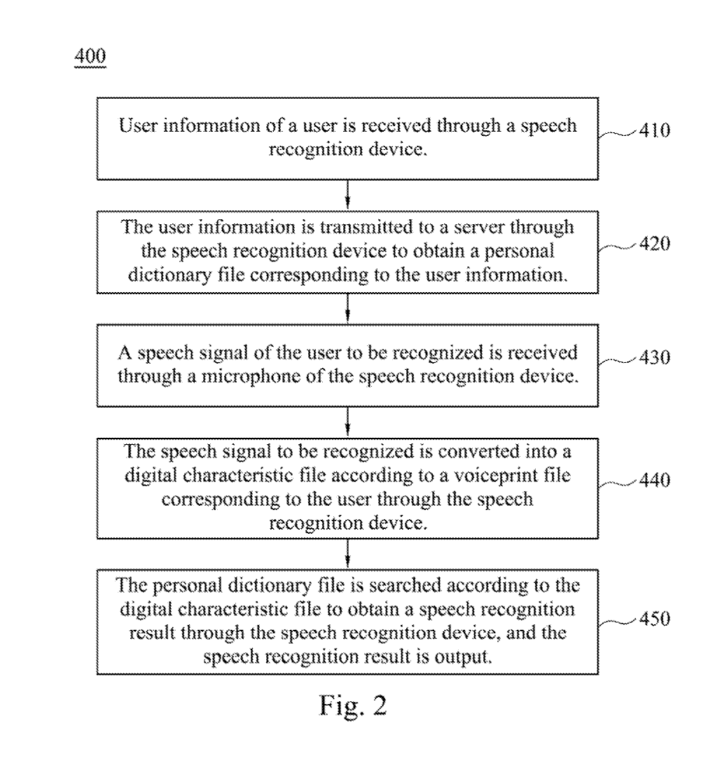

Referring to FIG. 2, a flow chart of a speech recognition method is illustrated according to one embodiment of this invention. The speech recognition method may be implemented in the form of a computer program product stored on a non-transitory computer-readable storage medium having computer-readable instructions embodied in the medium. Any suitable storage medium may be used, including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs), digital versatile disc read only memories (DVD-ROMs), and Blu-ray Disc read only memories (BD-ROMs); magnetic storage devices such as hard disk drives (HDDs) and floppy disk drives; and solid-state disks (SSDs). The speech recognition method 400 includes the following steps:

At step 410, user information of a user is received through a speech recognition device. In some embodiments of this invention, a user can input his or her information (such as identification information) through a keyboard, a mouse, a GUI or any other type of input interface to provide his/her information. In some other embodiments of this invention, a voice signal of the user may be received through a microphone of the speech recognition device. Subsequently, who the user is can be identified according to the voice signal of the user to generate an identification result. Then, the user information can be correspondingly generated according to the identification result for the speech recognition device to receive (step 410). In some embodiments, a user identification information corresponding to the voice signal of the user can be identified as the user information of the user. In some other embodiments, a sound category corresponding to the voice signal of the user, such as a language category, a corresponding accent category, or any other voice category, can be identified as the user information of the user.

At step 420, the user information of the user is transmitted to a server through the speech recognition device to obtain a personal dictionary file corresponding to the user information. For example, the speech recognition device can obtain the personal dictionary file formed by at least one common word commonly used by the user. To provide another example, the personal dictionary file can be obtained according to the user's language, the user's accent or any other voice parameter of the user embedded in the user information.

At step 430, a speech signal of the user to be recognized is received through a microphone of the speech recognition device.

At step 440, the speech signal of the user to be recognized is converted into a digital characteristic file according to a voiceprint file corresponding to the user through the speech recognition device.

At step 450, the personal dictionary file is searched according to the digital characteristic file to obtain a speech recognition result through the speech recognition device, and the speech recognition result is output. some embodiments of step 450, the speech recognition result can be displayed (output) through a display unit. In some other embodiments of step 450, the speech recognition result may be output in form of a corresponding sound some other embodiments of step 450, any other output method can be utilized for outputting the speech recognition result, which should not be limited in this disclosure. Therefore, the speech recognition device can recognize speech precisely without needing to store a large number of dictionary files. Accordingly, a processing unit with poor processing efficiency or a storage unit with a small storage space can be utilized for the speech recognition device.

Moreover, in some embodiments of this invention, information regarding whether the speech recognition result is correct or not may be received through the server, such that the server can update the personal dictionary file according to the received information. The information regarding whether the speech recognition result is correct or not may be received through a keyboard, a mouse, a GUI or any other type of output interface. In some other embodiments, another speech signal received through the microphone is the same as the previous users speech signal to be recognized, it is determined that the speech recognition result is erroneous. Therefore, when the user notices that the speech recognition result is erroneous, he/she can simply repeat the word or sentence the same as the previous one to drive the speech recognition device to determine that the speech recognition result is erroneous and to amend its speech recognition result, which is easy for users to operate.

In addition, the server may further receive the speech recognition result. Hence, a related dictionary file can be transmitted to the speech recognition device according to the speech recognition result through the server as the basis for performing search at step 450. For example, when the speech recognition result is related to weather, the server may transmit a dictionary related to weather to the speech recognition device. The dictionary related to weather may storeword's or sentences about weather. Therefore, the recognition correctness ratio of the speech recognition device can be raised. In addition, extra time for modifying the speech recognition result or for re-transmitting another dictionary due to incorrect speech recognition results can be saved.

In some embodiments, the speech recognition device may store a preset dictionary file. The speech recognition method 400 may further include the step of using the preset dictionary file as the personal dictionary file when the speech recognition device cannot identify the user information of the user. Therefore, when the user cannot be identified due to log-in for the first time or any other reason, the basic speech recognition function can be provided through the preset dictionary file.

In some other embodiments of this invention, conversation content from the user and the speech-recognition history information of the user can be recorded. A currently used dictionary file can be generated according to the recorded conversation content from the user and the speech-recognition history information of the user. The currently used dictionary file is then stored in the server. Then, the server may take the currently used dictionary file as the personal dictionary file corresponding to the user's information.

In some other embodiments of this invention, the server may generate and store a recently used dictionary file according to a speech recognition service history provided by itself. Hence, the recently used dictionary file may fit habits of local users served by the server. When a recognition correctness rate using the currently used dictionary file as the personal dictionary file corresponding to the user's information is lower than a threshold value, the recently used dictionary file is then utilized for performing the speech recognition. Since the user operating the speech recognition device may be similar to local users server by the server, the recognition correctness rate may be improved according to the recently used dictionary file.

In some other embodiments of this invention, the server may store a private dictionary file of the user, which stores at least one common word used by the user. Hence, the user's currently used dictionary file can be modified according to the private dictionary file of the user to fit the user's habit.

In some other embodiments of this invention, the server may further store several professional dictionary files corresponding to several professional categories. In some embodiments, the professional dictionary files can be stored in one single local server. In some other embodiments, the professional dictionary files can be stored in at least one cloud server to provide to the local server for performing searching. In the speech recognition method 400, at least one category needed to be modified may be obtained. In some embodiments, a specific category may be taken as the category needed to be modified when its recognition-error ratio is high. Then, the personal dictionary file corresponding to the user information can be modified according to the professional dictionary files corresponding to the category needed to be modified. Therefore, the personal dictionary file can be modified according to categories of different words, such that the recognition correctness ratio can be enhanced.

Although the present invention has been described in considerable detail with reference to certain embodiments thereof, other embodiments are possible Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A speech recognition system, comprising:
a server;
a data transmission interface; and
a speech recognition device building a connection with the server through the data transmission interface, wherein the speech recognition device comprises:
a microphone;
an output unit; and
a processing unit electrically connected to the microphone and the output unit, wherein the processing unit comprise
a user-information receiving module configured to receive user information of a user;
a personal-dictionary obtaining module configured to transmit the user information to the server through the data transmission interface to obtain a personal dictionary file corresponding to the user information;
a speech-signal receiving module configured to receive a speech signal of the user to be recognized through the microphone;
an audio converting module configured to convert the speech signal to be recognized into a digital characteristic file according to a voiceprint file corresponding to the user; and
a searching module configured to search the personal dictionary file according to the digital characteristic file to obtain a speech recognition result, and to output the speech recognition result through the output unit.

2. The speech recognition system of claim 1, wherein the processing unit further comprises:
a voice identifying module configured to receive a voice signal of the user through the microphone, to identify who the user is according to the voice signal to generate an identification result, and to correspondingly generate the user information according to the identification result.

3. The speech recognition system of claim 1, wherein the server comprises:
an update module configured to update the personal dictionary file according to information regarding whether the speech recognition result is correct or not, which is received from the speech recognition device through the data transmission interface.

4. The speech recognition system of claim 3, wherein the processing unit further comprises:
a recognition-error determining module, wherein, when another speech signal received through the microphone is the same as the previous speech signal of the user to be recognized, the recognition-error determining module determines that the speech recognition result is erroneous.

5. The speech recognition system of claim 1, wherein the server comprises:
a related-dictionary providing module configured to receive the speech recognition result through the data transmission interface, and to transmit a related dictionary file to the speech recognition device according to the speech recognition result for the searching module to perform searching.

6. A speech recognition method, comprising:
(a) receiving user information of a user through a speech recognition device;
(b) transmitting the user information to a server through the speech recognition device to obtain a personal dictionary file corresponding to the user information;
(c) receiving a speech signal of the user to be recognized through a microphone of the speech recognition device;
(d) converting the speech signal to be recognized into a digital characteristic file according to a voiceprint file corresponding to the user through the speech recognition device; and
(e) searching the personal dictionary file according to the digital characteristic file to obtain a speech recognition result through the speech recognition device, and outputting the speech recognition result.

7. The speech recognition method of claim 6, further comprising:
receiving a voice signal of the user through the microphone of the speech recognition device; and
identifying who the user is according to the voice signal to generate an identification result, and correspondingly generating the user information according to the identification result.

8. The speech recognition method of claim 6, further comprising:
receiving information regarding whether the speech recognition result is correct or not from the speech recognition device through the server, wherein the server updates the personal dictionary file according to the information regarding whether the speech recognition result is correct or not.

9. The speech recognition method of claim 8, further comprising:
determining that the speech recognition result is erroneous when another speech signal received through the microphone of the speech recognition device is the same as the previous speech signal of the user to be recognized.

10. The speech recognition method of claim 6, further comprising:
receiving the speech recognition result through the server; and
transmitting a related dictionary file to the speech recognition device according to the speech recognition result through the server.

11. The speech recognition method of claim 6, wherein the speech recognition device stores a preset dictionary file, and the speech recognition method further comprises:
using the preset dictionary file as the personal dictionary file when the speech recognition device cannot identify the user information.

12. The speech recognition method of claim 6, further comprising:
generating a currently used dictionary file according to conversation content from the user and speech-recognition history information of the user and storing the currently used dictionary file in the server, wherein the server uses the currently used dictionary file as the personal dictionary file corresponding to the user information.

13. The speech recognition method of claim 12, wherein the server further stores a recently used dictionary file, wherein the recently used dictionary file is generated according to a speech recognition service history provided by the server, wherein the speech recognition method further comprises:
when a recognition correctness rate using the currently used dictionary file as the personal dictionary file corresponding to the user information is lower than a threshold value, utilizing the recently used dictionary file for performing the speech recognition.

14. The speech recognition method of claim 12, wherein the server further stores a private dictionary file of the user, and the private dictionary file stores at least one common word used by the user, and the speech recognition method further comprises:
modifying the currently used dictionary file according to the private dictionary file of the user.

15. The speech recognition method of claim 6, wherein the server further stores a plurality of professional dictionary files corresponding to a plurality of professional categories, and the speech recognition method further comprises:
obtaining at least one category needed to be modified; and
modifying the personal dictionary file corresponding to the user information according to the professional dictionary files corresponding to the category needed to be modified.
